(19) United States
(12) Patent Application Publication
(10) Pub. No.: US 2013/0297401 A1
(43) Pub. Date: Nov. 7, 2013

(54) SYSTEM, APPARATUS, AND METHOD FOR ORIENTED SWITCH OF PROMOTION INFORMATION

(71) Applicant: Liangjian YU, Beijing (CN)

(72) Inventor: Liangjian YU, Beijing (CN)

(21) Appl. No.: 13/935,351

(22) Filed: Jul. 3, 2013

Related U.S. Application Data
(63) Continuation of application No. 12/754,897, filed on Apr. 6, 2010.

(30) Foreign Application Priority Data
Dec. 14, 2009 (CN) 200910250505.2

(51) Int. Cl. G06Q 30/02

(52) U.S. Cl. CPC G06Q 30/0238
USPC 705/14.38

(57) ABSTRACT

The present invention discloses a method of printing promotion information, comprises receiving data to be printed from the POS terminal; in response to the data to be printed, determining promotion information according to policy conditions; and printing the data to be printed from the POS terminal and the promotion information. The present invention constructs a platform for cooperation of different publishers of the promotion information and oriented switch of the promotion information. Moreover, the present invention utilizes the existing POS systems with low cost for configuration and distribution which is further advantageous on implementation.

### CROSS-REFERENCE TO RELATED APPLICATION

This application claims foreign priority benefits 35 U.S.C. §119 to Chinese Patent Application Serial No. 200910250505.2, filed on Dec. 14, 2009, the disclosure of which are incorporated herein by reference.

### TECHNICAL FIELD OF THE INVENTION

The present invention relates to a technique of publishing promotion information, particularly to a system, apparatus, and method for oriented switch of promotion information, in which publishers of promotion information can cooperate and provide promotion information in response to different customers.

### BACKGROUND OF THE INVENTION

Promotion information in form of coupons is favored by customers all over the world and issuance of coupons is an approach of sale promotion (SP) frequently used by restaurants, dress shops, convenience stores, supermarkets, and the like (“publishers”). Generally, coupons can be classified as promotion coupons before consumption and re-consumption encouraging coupons after consumption. However, there exist some apparent problems on issuance of the coupons no matter which kind of coupons they are.

Promotion coupons usually are printed by the publisher at the same position and then the coupons are distributed through different ways. Some coupons are handed around by persons employed by the publisher, some coupons are accessed on the website of the publisher for self-printing by the customers, and some coupons are delivered together with newspapers, magazines, admission tickets, and the like. The problems of this method are apparent: first, since a mass of coupons are printed in a concentrated manner, cost for coupon printing is very high; second, only one or several kinds of coupons are available to all the customer and the efficiency of coupon issuance is very low; finally, the choice of the customers is very limited because only the publisher's coupons are provided to the customers.

Re-consumption encouraging coupons are usually available at the business points of the publisher and provided to the customers when they consume. However, the publisher gives only re-consumption encouraging coupons of itself and categories of the coupons are very limited. The customers still have no or only a few of choices of the coupons. Furthermore, the different publishers cannot cooperate and combine their advantages in the promotion.

In addition to the above, there is also an independent coupon printer on the market. The coupon printer shows the customers a number of coupons and can print the coupons or send electronic coupons according to the customer's choices. Although the customs have a certain choice by means of the coupon printer, the publishers cannot establish a direct connection with the customers and thus the publishers have to only provide the coupons with direct discount which can be obtained by most customers. Clearly, the independent coupon printer cannot realize cooperation of the publisher, for example switching promotion information, and oriented issuance of the coupons aiming at different customers.

### SUMMARY OF THE INVENTION

The present invention is directed to above technical problems, and its objective is to provide a system and method for oriented switch of promotion information.

According to one aspect of the present invention, it is provided with an apparatus between a POS terminal and a printer, which comprises: a printer module configured to receive data to be printed from the POS terminal; and a control module configured to, in response to the data to be printed, determine promotion information according to policy conditions, wherein the printer is further configured to receive the promotion information from the control module and transfer the data to be printed and the promotion information to the printer.

According to a second aspect of the present invention, it is provided with a system for oriented switch of promotion information, comprising: a plurality of POS terminal; a plurality of printer; a plurality of switch terminals between the plurality of POS terminals and printer; wherein the switch terminal comprises: a printer module configured to receive data to be printed from the POS terminal; and a control module configured to, in response to the data to be printed, determine promotion information according to policy conditions, wherein the printer is further configured to receive the promotion information from the control module and transfer the data to be printed and the promotion information to the printer.

According to a third aspect of the present invention, it is provided with a method of printing promotion information, comprises: receiving data to be printed from the POS terminal; in response to the data to be printed, determining promotion information according to policy conditions; and printing the data to be printed from the POS terminal and the promotion information.

According to a fourth aspect of the present invention, it is provided with a method for oriented switch of promotion information, comprises: providing a plurality of pieces of promotion information; classifying the plurality of pieces of promotion information into categories; deciding policy conditions corresponding to each of the categories; and providing a piece of promotion information when the corresponding policy conditions are satisfied.

### BRIEF DESCRIPTION OF THE DRAWINGS

FIG. 1 is a frame diagram of a system for oriented switch of promotion information according to one embodiment of the present invention;

FIG. 2 is a frame diagram of the switch terminal according to one embodiment of the present invention;

FIG. 3 is a frame diagram of the switch terminal according to another embodiment of the present invention;

FIG. 4 is a diagram of printer module operated in a serial status according to one embedment of the present invention;

FIG. 5 is a diagram of printer module operated in a bypass status according to one embedment of the present invention;

FIG. 6 is a diagram of a specific example of the programmable IC as shown in FIGS. 4 and 5 according to the present invention;

FIG. 7 is a flowchart of a method for printing the promotion information according to one embedment of the present invention;

FIG. 8 is a flowchart of a method for printing the promotion information according to another embedment of the present invention;

FIG. 9 is a diagram illustrating an update of policy conditions according to one embodiment of the present invention;

FIG. 10 is a flowchart illustrating a method for providing promotion information based on policy conditions according to one embodiment of the present invention;

FIG. 11 is a diagram illustrating an example of a receipt with printed promotion information together with the check-out information;

FIG. 12 is a diagram illustrating a method of publishing promotion information according to one embodiment of the present invention;

FIG. 13 is a diagram illustrating a method of issuing promotion information according to one embodiment of the present invention.

### DETAILED DESCRIPTION OF THE INVENTION

It is believed that the above and other objectives, features and advantages of the present invention will become clearer through the following detailed description of the embodiments of the present invention in conjunction with the drawings.

In order to realize the cooperation of the publishers, the present invention provides a mechanism for the publishers inter-printing their promotion information and issuing promotion information in an oriented manner according to certain policies for publishing promotion information based on wide-spread POS (Point-Of-Sale) system.

POS system in which customer check-out information (e.g. item/cost) is printed as a receipt is used in restaurants, dress shops, convenience stores, supermarkets, and the like. That is, publishers of promotion information always have POS systems in their business points. A POS system comprises a POS terminal and a printer. For clarification, the operator uses a barcode reader of the POS terminal to read the barcode on a product, the price information of the product are inputted and stored in a memory of the POS terminal, and then which all the products are scanned, the cost are calculated and paid also with the POS terminal. Finally, the check-out information is sent from the POS terminal to the printer for printing the receipt. The information to be printed may include product/item names, service names, item or total price, payment, time, and so on. If the customer uses a credit card, the information may also include the card holder's name and the credit card number. The present invention takes advantages of the existing wide-spread POS systems and thus accomplishes issuance of promotion information with low cost. The present invention adds a switch terminal between the POS terminal and the printer. Generally, the switch terminal can be integrated with the printer. Of cause, the switch terminal can be integrated with the POS terminal, or the three apparatuses can be integrated as a device. The switch terminals can be inter-connected to form a switch terminal network and be connected to a server through a network.

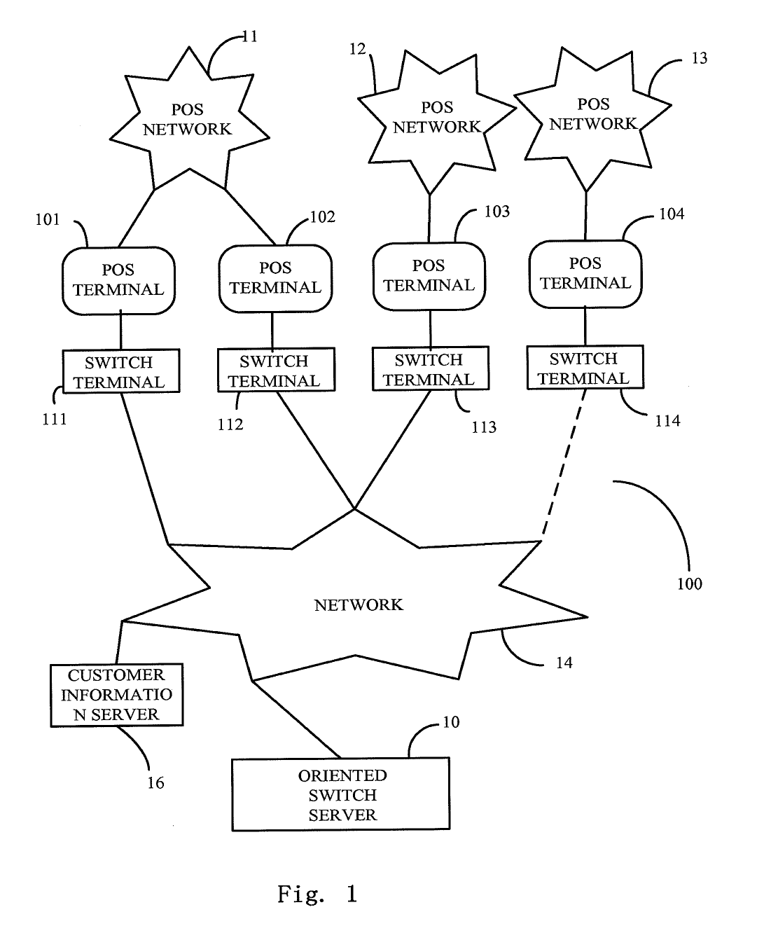

FIG. 1 is a frame diagram of a system for oriented switch of promotion information according to one embodiment of the present invention. As shown in FIG. 1, the system 100 comprises POS terminals 101-104. Since a business point of the publisher can include more than one POS system, they can also form a POS network therein. For example, POS terminals 101 and 102 are in the network 11, and POS terminals 103 and 104 are respectively in the different networks 12 and 13. Switch terminals 111-114 are correspondingly connected to POS terminals 101-104. Printers (not shown) are integrated with the switch terminals or independently connected to the switch terminals respectively. Switch terminals 111-114 communicate with a network 14 which can be a wired network or wireless network. For example, Switch terminal 114 is connected with the network 14 in a wireless manner. Via the network 14, Switch terminals 111-114 are coupled to a server, i.e. oriented switch server. The oriented switch server stores all the promotion information and promotion policies for oriented switch. The switch terminals can download policy conditions and promotion information from the server and store them in a memory thereof. For example, the switch terminals usually stores mostly used promotion information. In an example, the server can be accessed by a web client through which the promotion information and promotion policies may be modified. The system 100 also comprises a customer information server 16 connecting to the network 14 for providing customer's information in response to a request from the switch terminal.

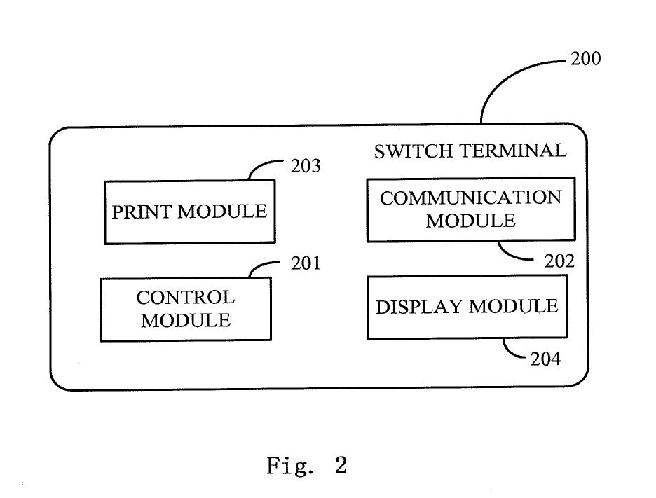

FIG. 2 is a frame diagram of the switch terminal according to one embodiment of the present invention. As shown in FIG. 2, the switch terminal 200 comprises a control module 201, a communication module 202, a printer module 203 (described in details as follows) and a display module 204. Control module 201 for example a CPU module is the core of the switch terminal. Control module 201 monitors and analyzes contents to be printed by the printer module, retrieves promotion information from communication module 202 or a memory (not shown) thereof and forwards it to the printer module 203. Data to be printed has a universal format or a certain format corresponding to the printer. Control module 201 parses the data to be printed according to its format and extract contents to be printed for analysis. Control module 201 determines promotion information needed to be printed together according to policy conditions stored for example in the memory. Communication module 202 communicates with for example the oriented switch server, receives promotion information from the server, and update of the policy conditions. In one embodiment, Communication module 202 synchronizes with the oriented switch servers and acquires updated policy conditions and promotion information immediately. Communication module 202 also communicates with the customer information server via a network. For example, communication module can send a request including a customer's name to the customer information server for other information of the customer. Control module 201 also controls the policies and statuses of the policies. In response to the receiving updates of the policy conditions, control module 201 changes the policy conditions stored. Display module 204 is an optional one for the switch terminal. Display module 204 displays promotion information to be printed to the customer.

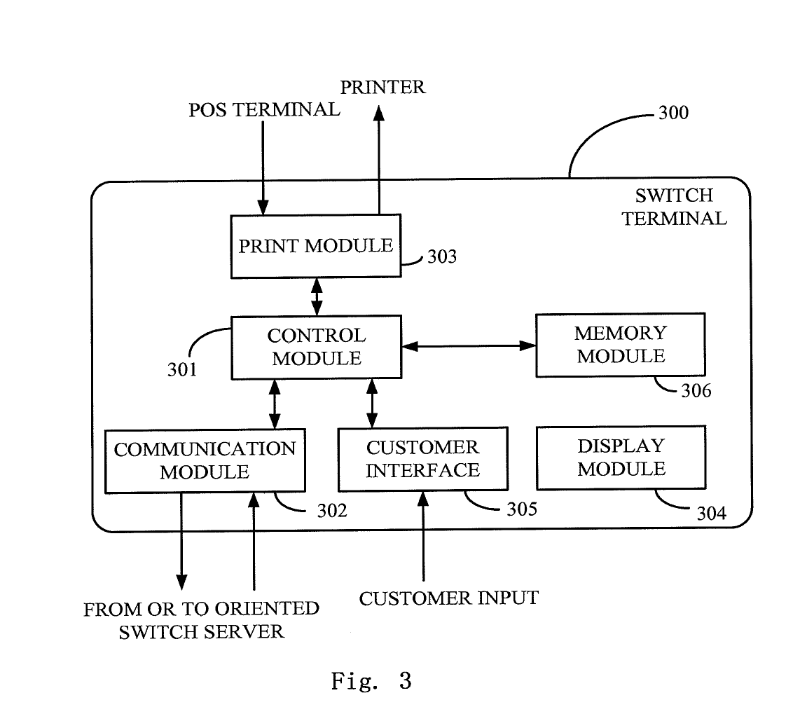

FIG. 3 is a frame diagram of the switch terminal according to another embodiment of the present invention. As shown in FIG. 3, the switch terminal 300 comprises a control module 301, a communication module 302, a printer module 303 (described in details as follows) and a display module 304. The switch terminal 300 further comprises a customer interface 305, and a memory module 306. Control module 301 monitors and analyzes contents to be printed by the printer module, retrieves promotion information from communication module 302 or memory module 306 and forwards it to the printer module 303. Control module 301 parses the data to be printed according to its format and extract contents to be printed for analysis. Control module 301 determines promotion information needed to be printed together according to policy conditions stored in the memory module 306. Communication module 302 communicates with the oriented switch server, receives promotion information from the server, and update of the policy conditions. Communication module 302 also communicates with the customer information server via a network. Control module 301 also controls the policies and statuses of the policies. In response to the receiving updates of the policy conditions, control module 301 changes the policy conditions stored.

Display module 304 is an optional one for the switch terminal. Display module 304 displays promotion information to be printed to the customer. The customer can select desire coupons displayed in the display module 304 through customer interface 305. The examples of the customer interfaces 305 can be a touch screen, a keyboard, a mouse, a pointed device, and the like.

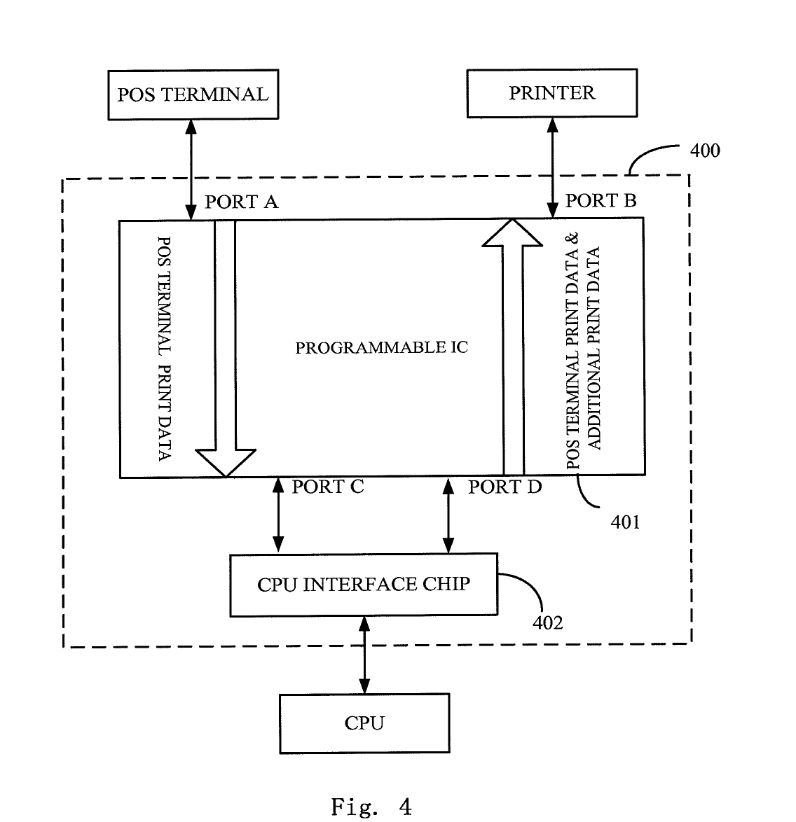

The printer module of the present invention is described in a detailed manner in combination of FIG. 4-6. In accordance with various requirements, the printer module can be operated in different statuses: a serial status and a bypass status. FIG. 4 is a diagram of printer module operated in a serial status according to one embedment of the present invention. As shown in FIG. 4, the printer module 400 includes a programmable IC 401 and a CPU interface chip 402. Examples of programmable IC include, but not limit to, CPLD (Complicated Programmable Logical Device)/FPGA (Field-Programmable Gate Array). The CPU interface chip is necessary or not according to the CPU which the programmable IC is connected to. In an embodiment, the CPU interface chip can be FTD (Frequency/Time Descriptor), for example FTD122332, or other interfaces.

In one embodiment, the programmable IC comprises 4 ports. For example, in a parallel mode, Port A is a parallel port connecting to parallel port for print of the POS terminal and Port B is a parallel port for print connecting to the printer. Port C is a data upload port and Port D is a data download port. Ports C and D are connected to communication ports of the CPU interface chip as shown in FIG. 4 or to the CPU directly. The communication protocol between the Ports C and D and the CPU can be any adaptable protocol, for example the USB protocol.

In a serial status as shown in FIG. 4, the programmable IC 401 receives data to be printed from the POS terminal at Port A and transfers the received data to Port C to upload the data to the CPU, which is an example of the control module as shown in FIGS. 2 and 3. The CPU stores and analyzes the POS terminal print data and then acquires corresponding promotion information. The CPU adds the promotion information as additional print data into POS terminal print data. The programmable IC 401 receives the POS terminal print data and additional print data at Port D and then transfers the two kinds of data to the Port B to send them to the printer. Accordingly, the data to be printed by the POS terminal and promotion information are printed.

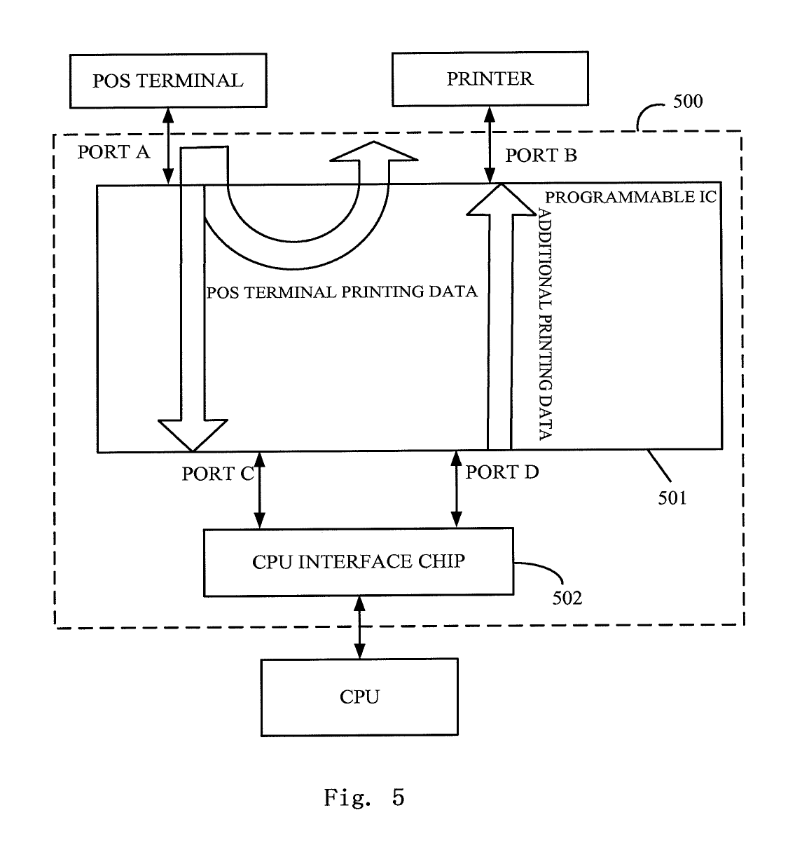

FIG. 5 is a diagram of printer module operated in a bypass status according to one embedment of the present invention. As shown in FIG. 5, the printer module 500 also comprises a programmable IC 501 and a CPU interface chip 502 and the programmable IC 501 comprises 4 ports. All the above features are similar to those in FIG. 4.

In a bypass status as shown in FIG. 5, the programmable IC 501 receives data to be printed from the POS terminal at Port A and directly forwards the received POS terminal print data to Port B. At the same time, Port A transfers the received data to Port C to upload the data to the CPU which is an example of the control module as shown in FIGS. 2 and 3. The CPU analyzes the POS terminal print data and then acquires corresponding promotion information as additional print data. The CPU then transmits the additional print data to the programmable IC. The programmable IC 401 receives the additional print data at Port D and then transfers the received data to Port B to send it to the printer. As a result, both the data to be printed by the POS terminal and promotion information are transmitted to the printer and printed.

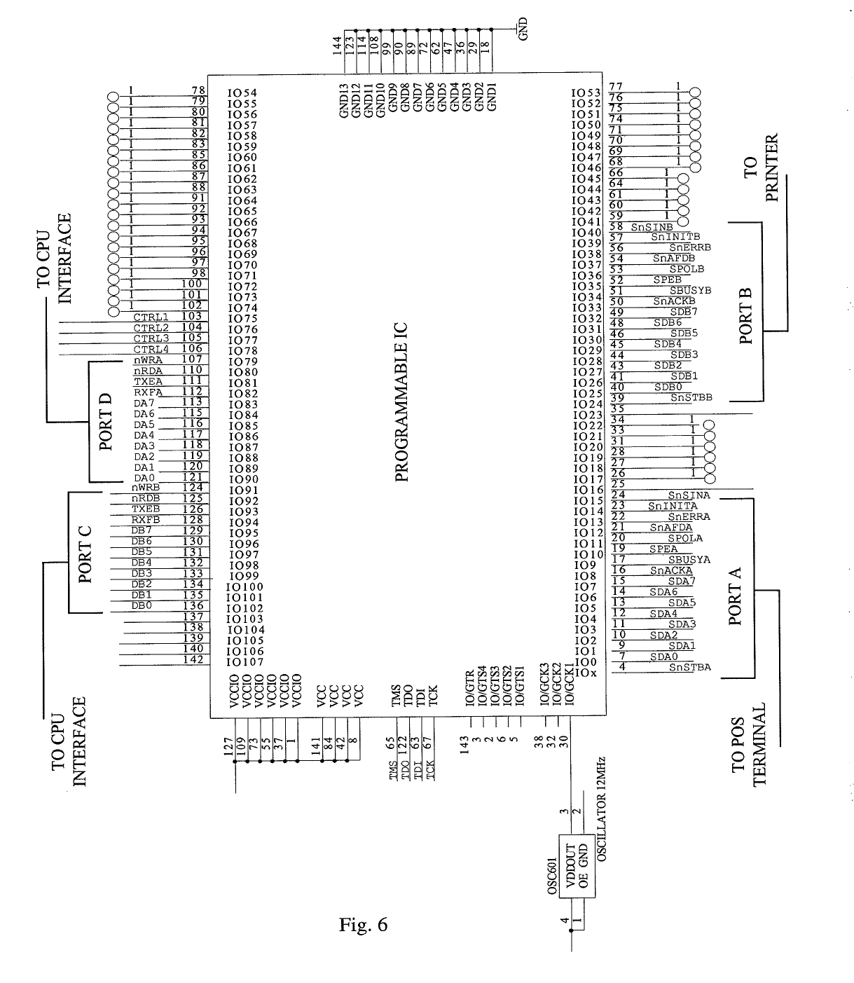

FIG. 6 is a diagram of a specific example of the programmable IC as shown in FIGS. 4 and 5 according to the present invention. As shown in FIG. 6, the programmable IC comprises Ports A-D functioned as described in the above description.

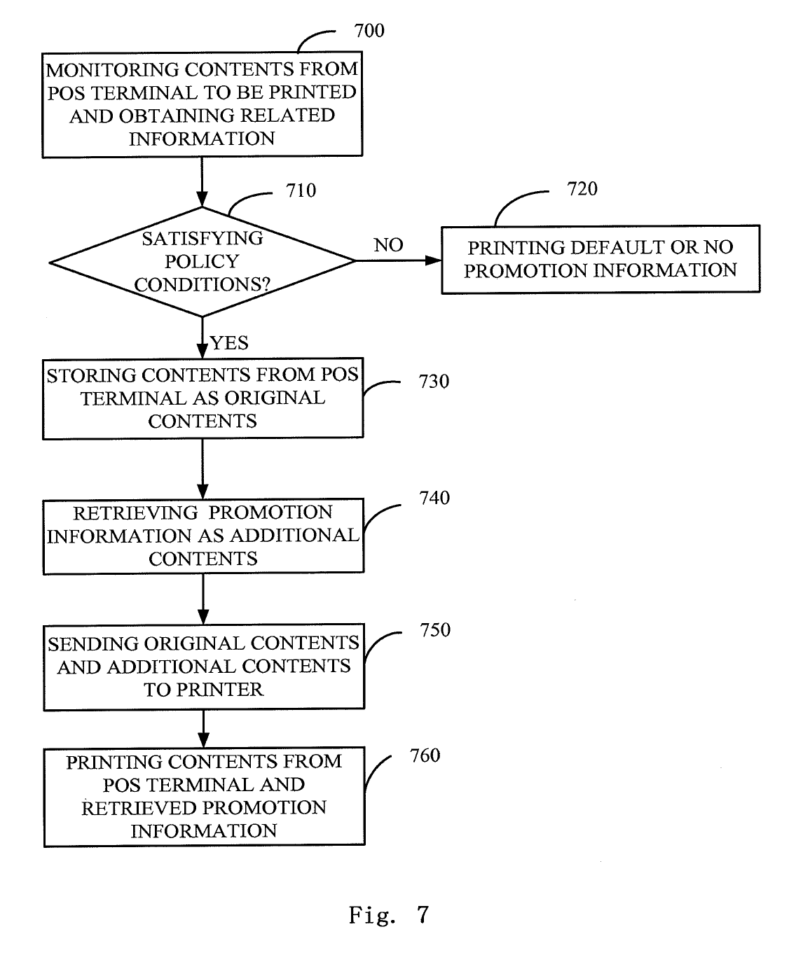

FIG. 7 is a flowchart of a method for printing the promotion information according to one embedment of the present invention. The method can be carried out when the print module is operated in a serial status as shown in FIG. 4. As shown in FIG. 7, at Step 700, contents from the POS terminal to be printed are monitored and information related to consumption is obtained. The contents sent from the POS terminal for print are used to print check-out receipts for customers. A lot of information is included or can be obtained from the contents, for example names of products or services, prices, amount of purchase, location of purchase, and time of purchase. If the customer uses a VIP card or other consumption card, the name, gender, age, address, and contact information can be known. If the customer uses a credit card, more information in addition to the above can be obtained, such as information about profession, family, credit records of the customer. With support of consumption historical records, which may be organized into a database, for example in a custom information server, behavior histories and preferences of the customer can also be acquired.

With the information directly extracted from the contents from the POS terminal, and the information obtained according to the extracted information, at Step 710, it is determined whether the customer's consumption satisfies the policy conditions. If it is not satisfied, at Step 720, no promotion information is printed, or one or more pieces of default promotion information are assigned and will be printed at Step 720. If it is satisfied, at Step 730, the contents from the POS terminal will be stored as original contents.

Then, according to matches between the customer's consumption and the policy conditions, at Step 740, one or more pieces of corresponding promotion information are retrieved as additional contents. At Step 750, both the original contents and additional contents are sent to the printer for print. Finally, at Step 760, both the contents from the POS terminal and corresponding promotion information are printed.

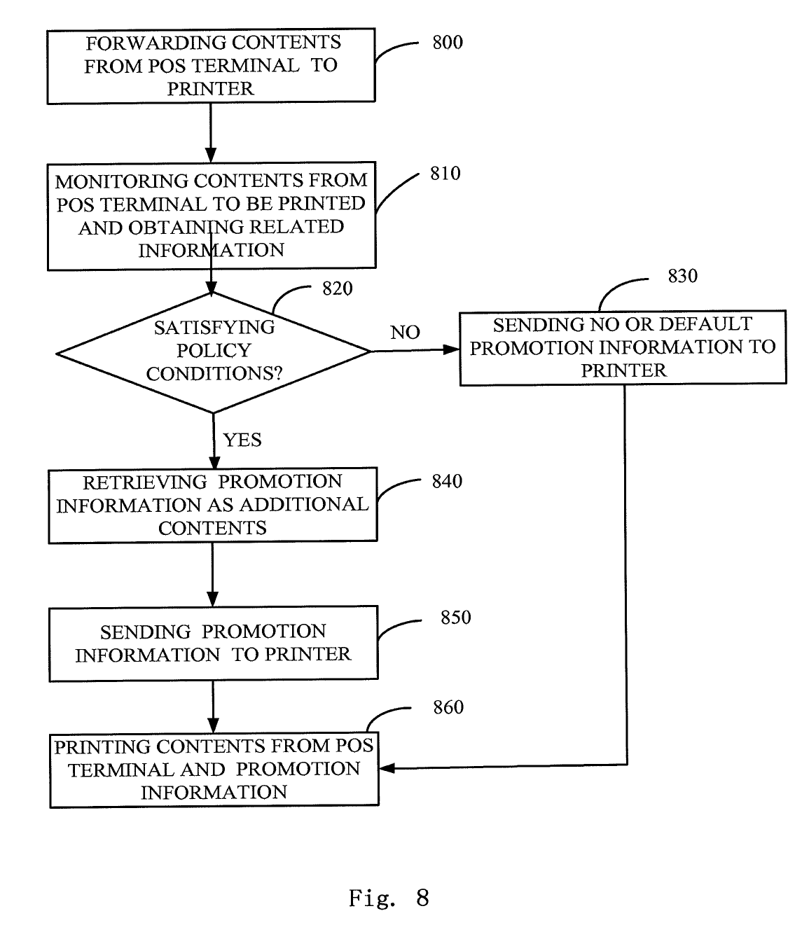

FIG. 8 is a flowchart of a method for printing the promotion information according to another embedment of the present invention. The method can be carried out when the print module is operated in a serial status as shown in FIG. 5. The same descriptions which are the same as those in FIG. 7 are omitted for conciseness.

As shown in FIG. 8, at Step 800, the contents from the POS terminal to be printed are forward to the printer directly. At the same time, the contents from the POS terminal to be printed are monitored and information related to consumption is obtained at Step 810. At Step 820, it is determined whether the customer's consumption satisfies the policy conditions. If it is not satisfied, at Step 830, no promotion information is sent to the printer, or only one or more pieces of default promotion information are sent for print. If it is satisfied, at Step 840, one or more pieces of corresponding promotion information are retrieved as additional contents according to matches between the customer's consumption and the policy conditions. At Step 850, the retrieved promotion information is sent to the printer. Finally, at Step 860, both the contents from the POS terminal and received promotion information are printed if available.

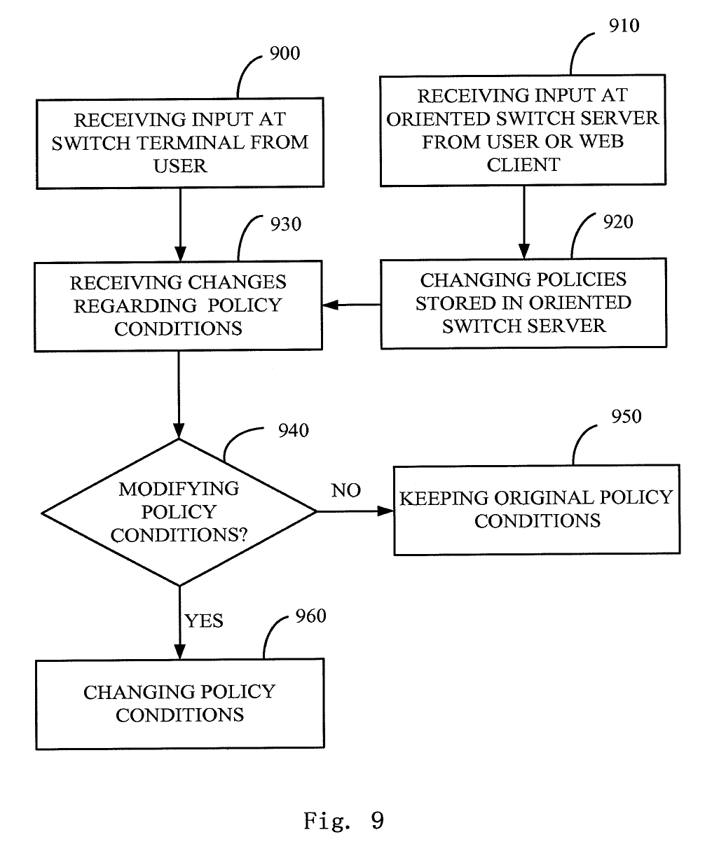

FIG. 9 is a diagram illustrating an update of policy conditions according to one embodiment of the present invention. As shown in FIG. 9, at Step 900, the switch terminal may receive an input regarding policy conditions from a user of the switch terminal. Usually, an operator working in a business point of a publisher is allowed to make some changes to the policy conditions. However, scope of modification to the policy conditions at the switch terminal is very limited. In some cases, the policy conditions are not allowed to be changed via the switch terminals and thus Step 900 may be omitted. At Step 910, the oriented switch server receives an input regarding policy conditions from a user, normally an administrator, or a web client via a network. At Step 920, the policies stored in the oriented switch server are changed. Then, since the switch terminals keeps consistency with the oriented switch server, the switch terminals receives changes regarding policy conditions at Step 930. In some cases, some business points only uses a portion of the policy conditions, if the used portion of policy conditions is not changed, the switch terminals of this business points need no modification. At Step 940, it is determined whether to modify the policy conditions stored in the switch terminals. If it is not needed, at Step 950, the original policy conditions are kept unchanged; if it is necessary, at Step 960, the policy conditions in the switch terminals are changed to keep consistent with the oriented switch server.

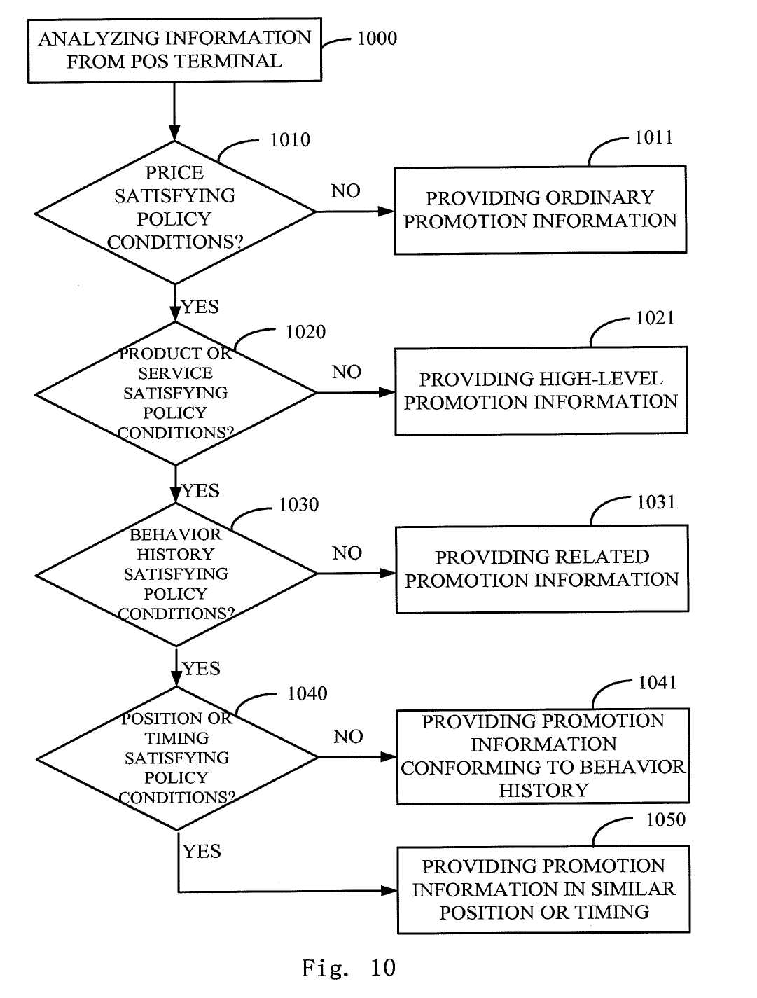

FIG. 10 is a flowchart illustrating a method for providing promotion information based on policy conditions according to one embodiment of the present invention. As shown in FIG. 10, at Step 1000, information from the POS terminal to be printed is analyzed to obtain related information according to the policy conditions. If some further information about the customer is required, it should be requested from the customer information server or other entities. With the information, at Steps 1010-1040, each piece of policy conditions is compared to see whether it is satisfied. According to numbers and/or levels of matched policy conditions, corresponding promotion information is provided at Steps 1011-1015.

Specifically, the price of the consumption is compared with the policy conditions at Step 1010. If it is not satisfied, a piece of ordinary promotion information will be provided at Step 1011. If it is satisfied, at Step 1020, the product or service of the purchase is checked to see whether it is included in the policy conditions. If it is not satisfied, a piece of random high-level promotion information will be provided at Step 1021. If it is satisfied, at Step 1030, the behavior history of the customer is checked to see whether it is satisfied with any policy conditions. If it is not satisfied, a piece of high-level promotion information with a similar kind of products and services randomly selected will be provided at Step 1031. If it is satisfied, at Step 1040, the position or timing of the consumption is checked to see whether it is satisfied with any policy conditions. If it is not satisfied, a piece of high-level promotion information with a similar kind of products and services conforming to the behavior history will be provided at Step 1041. If it is satisfied, at Step 1050, a piece of high-level promotion information with a similar kind of products and services conforming to the behavior history and position or timing will be provided.

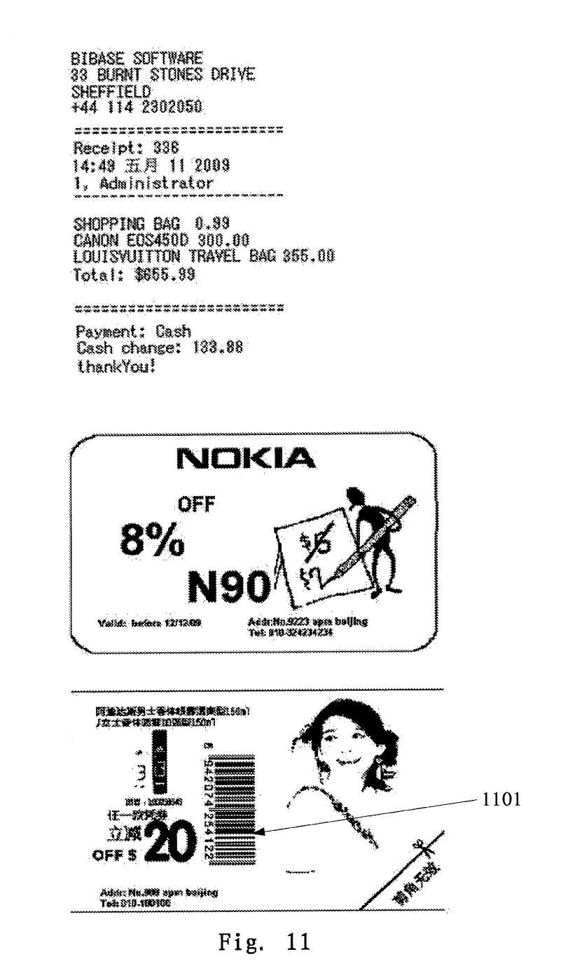

FIG. 11 is a diagram illustrating an example of a receipt with printed promotion information together with the check-out information. As shown in FIG. 11, an upper portion of the receipt shows the check-out information as an ordinary check-out receipt and a lower portion of the receipt contains a piece of promotion information, i.e. the coupon of Nokia. As illustrated, the receipt comprises a barcode at the bottom of the receipt. The barcode information is also stored, for example at the oriented switch server, to check whether the coupon is used by the customer or not. The barcode can also be calculated at least based on the total price of the consumption to prevent counterfeits.

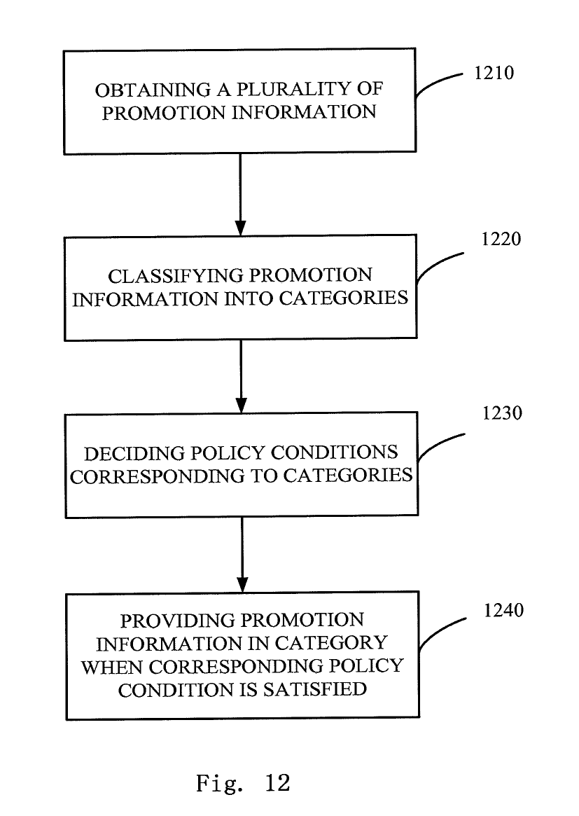

FIG. 12 is a diagram illustrating a method of publishing promotion information according to one embodiment of the present invention. As shown in FIG. 12, at Step 1210, a plurality of pieces of promotion information is obtained for issuance. At Step 1220, the plurality of pieces of promotion information is classified into more than one category. At Step 1230, for each category, corresponding policy conditions are decided. For all the categories, all of the policy conditions form the policies for publishing promotion information. At Step 1240, when the corresponding policy conditions are satisfied, promotion information in the corresponding category is provided. In this way, the present invention realizes the promotion information oriented promotion.

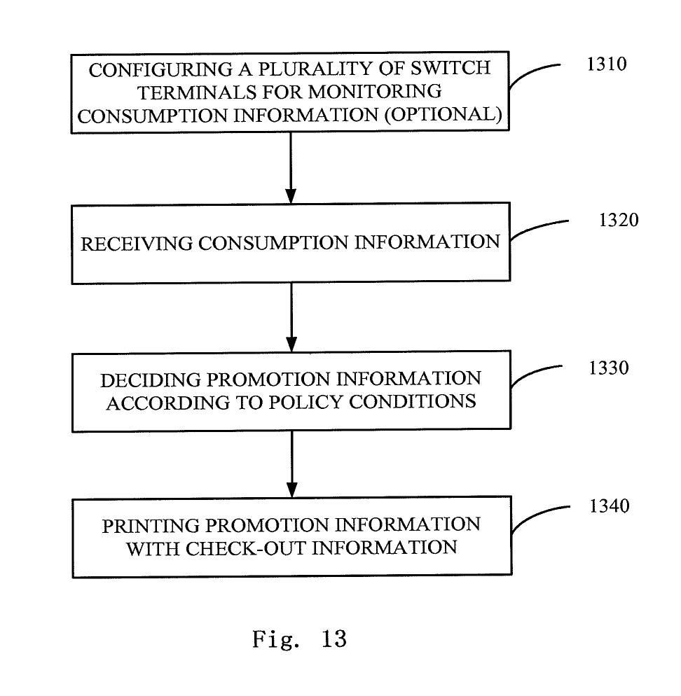

FIG. 13 is a diagram illustrating a method of issuing promotion information according to one embodiment of the present invention. As shown in FIG. 13, at Step 1310, conventional POS systems are modified according to the present invention and a plurality of switch terminals are configured to monitoring consumption information. In a system of the present invention, this step can be omitted. At Step 1320, the consumption information are received and, at Step 1330, according to the comparison between the consumption information and the policy conditions, it is decided which promotion information shall be provided to the customer. Finally, at Step 1340, the decided promotion information together with the check-out information is printed. In this way, coupons are provided to customers differently and selectively.

In the system of the present invention, since the business points share the same or several selected policies for publishing promotion information, at one business point, different and custom-oriented coupons will be provided accordingly. Therefore, the present invention constructs a platform for cooperation of different publishers of the promotion information and oriented switch of the promotion information. Moreover, the present invention utilizes the existing POS systems with low cost for configuration and distribution which is further advantageous on implementation.

Although the method and apparatus for ordering the search results, the search method and search engine based on the hierarchical data are described in detail in conjunction with the preferred embodiment, the present invention is not limited as above. It should be understood for persons skilled in the art that the above embodiments may be varied, replaced or modified without departing from the spirit and the scope of the present invention.

1-5. (canceled)

6. A system for oriented switch of promotion information, comprising:
a plurality of POS terminal;
a plurality of printer;
a plurality of switch terminals between the plurality of POS terminals and printer;
wherein the switch terminal comprises:
a printer module configured to receive data to be printed from the POS terminal; and
a control module configured to, in response to the data to be printed, determine promotion information according to policy conditions,
wherein the printer is further configured to receive the promotion information from the control module and transfer the data to be printed and the promotion information to the printer.

7. The system of claim 6, wherein the switch terminal further comprises a communication module configured to receive one of a group consisting of the promotion information, customer information, and update of the policy conditions.

8. The system of claim 7, further comprising an oriented switch server, wherein the plurality of switch terminals updates the policy conditions from the oriented switch server.

9. The system of claim 7, further comprising a customer information server, wherein the plurality of switch terminals request information from the customer information server.

10. The system of claim 6, wherein the policy conditions comprises more than one conditions each of which is corresponding to at least one piece of promotion information.

11-20. (canceled)
